(19) United States
(12) Patent Application Publication
(10) Pub. No.: US 2018/0315328 A1
(43) Pub. Date: Nov. 1, 2018

(54) METHOD AND SYSTEM FOR ADAPTIVE TIMING OF COMPUTER PROGRAMS

(71) Applicant: Aceable, Inc., Austin, TX (US)

(72) Inventors: Erin Defosse, Austin, TX (US); Marcela Gomez, Austin, TX (US); Kevin Nuut, Austin, TX (US); Seth Webber, Austin, TX (US)

(73) Assignee: Aceable, Inc., Austin, TX (US)

(21) Appl. No.: 15/967,612

(22) Filed: May 1, 2018

Related U.S. Application Data
(60) Provisional application No. 62/492,917, filed on May 1, 2017.

(51) Int. Cl. G09B 5/02; G09B 19/14; G09B 7/00

(52) U.S. Cl. CPC G09B 5/02; G09B 7/00; G09B 19/14

(57) ABSTRACT

The present disclosure relates to a method and system for adaptive timing. The system may utilize adaptable timers to recognize how well and how fast a student is progressing through a course. The timers may be adapted so that the remaining screens in the course presented to the user are given a timer setting that may show them a minimum amount of time needed to view each screen in order to finish the course in a minimum amount of time required by a regulatory body. The method may include identifying how far into the course the user is and calculating and presenting the minimum amount of time spent on each remaining screen of the course to the individual.

### CROSS-REFERENCE TO RELATED APPLICATIONS

This nonprovisional patent application claims the benefit of the filing date of provisional application 62/492,917, filed May 1, 2017, which is herein incorporated by reference.

### FIELD OF THE INVENTION

The present disclosure relates to a method and system for adaptive timing, more specifically a method and system for adaptive timing that may allow an individual to meet a minimum time requirement for a computer program, such as an online course.

### BACKGROUND OF THE INVENTION

Most licensing courses required for certification in regulated industries require that students spend a minimum amount of time “in the course” in order for the regulatory body to provide the student credit for taking it. These regulations are holdovers from brick-and-mortar classroom environments that usually specified the number of days or hours that a student would have to spend in a classroom in order to complete a course. For example, the course may be an online driver's education course accessible on a laptop or mobile device.

For online courses, most providers have implemented timers for each piece of content or screen shown to the user, preventing them from moving forward in the course until a set amount of time has elapsed. This allows program providers the ability to get an individual to meet a regulated minimum amount of time in a course. Usually these timers are implemented with either a fixed amount of time per screen or an amount that the provider estimates will be required by the student to read it. Because of these rigid timer configurations, many students find themselves having met or exceeded the minimum amount of time “in the course” required by the regulatory body yet still have to painfully go through the remaining course content with set timers. This results in unhappy customers who are spending more time than they should in the course, even if they successfully pass all of the assessments being presented to them throughout the course. Similarly, in other situations students may progress through the course too quickly to satisfy the minimum amount of “time in course” prescribed by the regulatory body because the course timers were set too short. In such situations, students may reach certain points in the course where they are held back from proceeding further or, worse yet, complete the course but have the results considered ineligible for credit by the regulatory body. This creates frustration with users who believe that they have met the objectives of the course but are not allowed to proceed or receive credit.

### BRIEF SUMMARY OF THE INVENTION

The disclosed subject matter provides a method and system for adaptive timing that may allow an individual to meet a minimum time requirement for a computer program, such as an online course. The system may utilize electronic devices, such as a cellular phone, a laptop, or a similar electronic device to provide adaptive timing to computer programs for completing goal oriented viewable content with a minimum time threshold.

The system may comprise an identified learning period identifier of a user that may be indicative of an amount of course content that the user has completed. The system may further comprise an identified threshold identifier for comparison with the identified learning period identifier in order to calculate a time differential between the learning period identifier and the threshold identifier. A time differential may be the minimum remaining time that an individual has in order to complete a course.

A processor may be configured to calculate an average screen view identifier for a remainder of the plurality of screens utilizing the time differential. An image viewer may be configured to present the average screen view identifier to the user for the remainder of the plurality of screens.

The method may be performed by a computer of the type having an image viewer and a processor, for providing adaptive timing of a computer program comprising a plurality of screens. To carry out the method, a processor may identify a learning period identifier of a user, which may be indicative of an amount of course content that the user has completed. The learning period identifier may then be compared to a threshold identifier in order to calculate a time differential between the learning period identifier and the threshold identifier.

An average screen view identifier may then be calculated by the processor for a remainder of the plurality of screens utilizing the time differential. Once the average screen view identifier is calculated, the identifier may be presented to the user for the remainder of the plurality of screens.

### BRIEF DESCRIPTION OF THE DRAWINGS

The novel features believed characteristic of the disclosed subject matter will be set forth in any claims that are filed now and/or later. The disclosed subject matter itself, however, further objectives, and advantages thereof, will best be understood by reference to the following detailed description of an illustrative embodiment when read in conjunction with the accompanying drawings, wherein:

FIG. 1 displays an embodiment of a computing system and related peripherals that may operate with the method and system for the adaptive timing of computer programs.

FIG. 2 displays an embodiment of a process flow diagram embodying a method for adaptive timing of computer programs.

FIG. 3 displays an embodiment of a process flow diagram embodying a method for adaptive timing of computer programs.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

Illustrative System

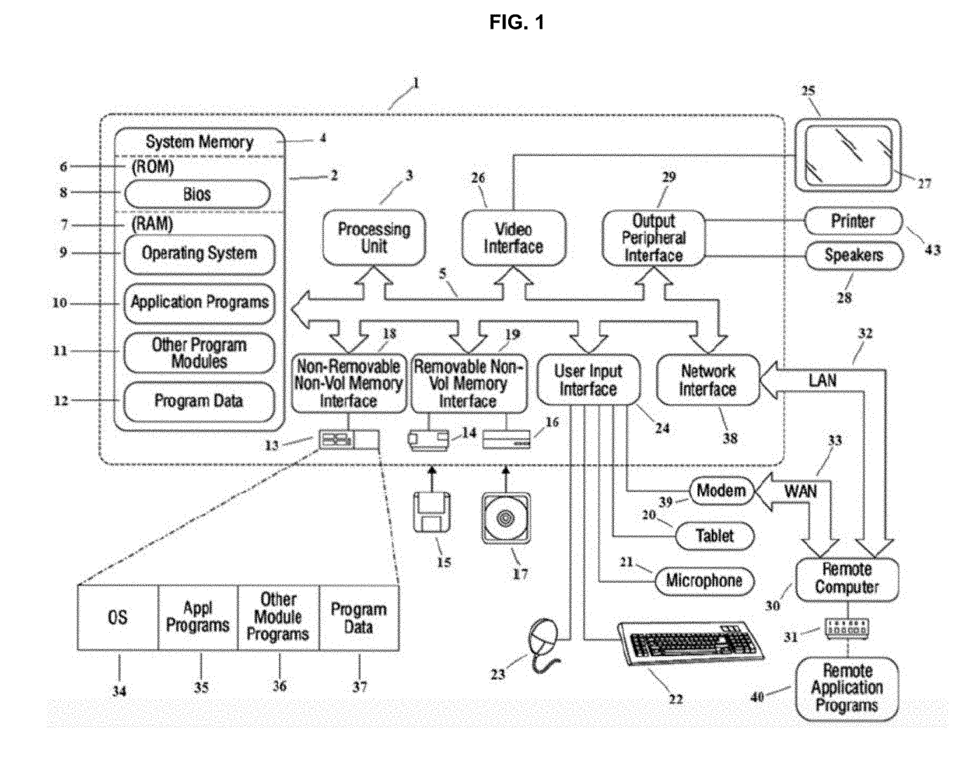

With reference to FIG. 1, an exemplary system within a computing environment for implementing the disclosure includes a general purpose computing device in the form of a computing system 1, commercially available from, for example, Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system (BIOS) 8, containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11, and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36, and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel 27 or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 28 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 32 connecting through network interface 38 and a wide area network (WAN) 33 connecting via modem 39, but may also include other networks. Such networking environments are commonplace in offices, enterprise-wide computer networks, intranets, and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

Referring to FIG. 1, for the purposes of this disclosure, it will be appreciated that remote computer 30 may include any suitable terms such as, but not limited to “device”, “processor based mobile device”, “mobile device”, “electronic device”, “processor based mobile electronic device”, “mobile electronic device”, “wireless electronic device”, “location-capable wireless device,” and “remote device” including a smart phone or tablet computer.

The central processor operating pursuant to operating system software such as, but not limited to Apple IOS®, Google Android®, IBM OS/2®, Linux®, UNIX®, Microsoft Windows®, Apple Mac OSX®, and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation, and algorithm generation. The provided functionality may be embodied directly in hardware, in a software module executed by a processor, or in any combination of the two.

Furthermore, software operations may be executed, in part or wholly, by one or more servers or a client's system, via hardware, software module, or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

To carry out a process of adaptive timing, any portion of system 1 may be utilized in conjunction with a number of data points that may be identified when an individual is utilizing a computer program including course content (not shown) in conjunction with system 1. The data points may be identified and stored on the system memory 4.

At a certain point in time when an individual is utilizing the course content, a learning period identifier may be identified by the processor 3 and associated with a user. This learning period identifier may be indicative of an amount of course content that a user has completed or accessed. It is noted that the “amount” of course content may be a measurement such as time, percentage of the course completed, etc.

Many online courses typically have a preset range of time in which an individual is to complete the course. This range of time may include a minimum amount of time in order to complete the course and a maximum amount of time in order to complete the course. A threshold identifier may be stored on the system memory 4 that may be indicative of the minimum amount of time in order to complete the course. Once the learning period identifier is found, the processor 3 may calculate a time differential between the learning period identifier and the threshold identifier. This differential may indicate the minimum amount of time a user may be allowed in order to view the remainder of the screens in the course.

Once the differential is calculated, the processor 3 may recalculate an average screen view identifier for the remainder of the screens that the user needs to view so that the user may complete the course in the minimum amount of time allotted. In embodiments, the average screen view identifier may be calculated at any point in time after a user has viewed at least one screen in the course. This average screen view identifier may be presented to the user via an image viewer 25 for the remainder of the plurality of the screens that the user has to view before completing the course.

Illustrative Processes

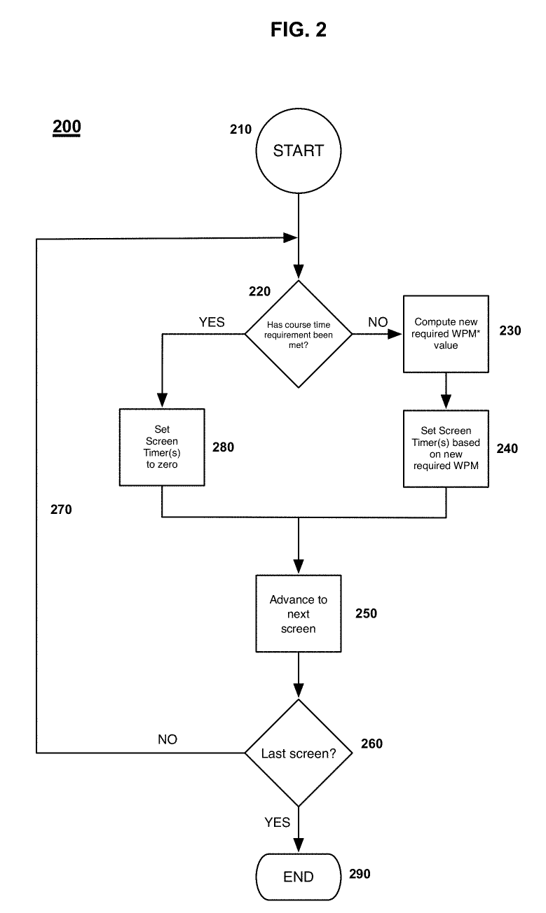

FIG. 2 displays an embodiment of a process flow diagram embodying a method 200 for adaptive timing of computer programs comprising a plurality of screens. In order to carry out method 200, the computer system 1 may analyze whether a user has met the threshold identifier. If the user has reached the threshold identifier, an average screen view identifier may not be displayed to the user via image viewer 25, thus indicating that the user has completed the minimum amount of time for the course even though the user has not viewed all necessary screens in the course. The user may advance to the remaining screens in order to complete the course. Once the user has reached the last screen, the course may end.

If the user has not reached the threshold identifier, the computer system 1 may identify a learning period identifier that is indicative of an amount of course content that the user has completed (number of screens looked at, percentage of course complete, etc.). The processor may then compare the learning period identifier to the threshold identifier in order to calculate a time differential between the learning period identifier and the threshold identifier. This time differential may be indicative of the minimum amount of time remaining that the user has in order to view the remaining screens of the course.

The computer system 1 may then calculate an average screen view identifier for a remainder of the plurality of screens using the time differential. This may be the minimum amount of time an individual has to view each remaining slide in the course. An image viewer may present the average screen view identifier to the user for the remainder of the plurality of screens.

In embodiments, the computer system 1 may detect when a user has satisfied the minimum amount of time in course and then eliminate the display of the screen timers for any remaining screens left to cover. For example, if a student is taking a six (6) hour course and has reached the six (6) hour requirement with 75% of the course completed, the remaining 25% of the course may be presented to the user with no timers since the user has met the minimum time period (identified as the threshold identifier).

In embodiments, the system 1 may measure how fast users complete course content on each screen. The average screen view identifier may be continuously adjusted for future screens to ensure that the student spends no more than the required amount of time in a course. For example, if a user is taking a ten (10) hour course (600 minutes or 36,000 seconds) of one thousand (1000) screens with timers set to thirty-six (36) seconds per screen and is averaging twenty (20) seconds per screen, the system 1 may reduce the average screen view identifier to twenty (20) seconds per remaining screen while also introducing breaks into the course that account for the remaining time in order to meet the required minimum amount of time in the course.

In embodiments, the average screen view identifier may be the number of words on a specific screen. In other embodiments, the average screen view identifier may vary for the remaining screens due to word count per screen. In other embodiments, the word count may be based on at least one of an entire number of words in a course, an entire number of words in a chapter, a number of words on a screen, etc.

In embodiments, the system 1 may determine, based on the content of a course, a minimum amount of time for a chunk of the course (such as a chapter) and may set the original timers based strictly on that information. As a user views screens of the course and spends more time on a screen than the given average screen view identifier has depicted, the minimum time required for the chapter may increase, allowing the average screen view identifier for the remaining screens in the chapter to display a shorter amount of time. A certain amount of time may be able to be given per screen in order to ensure that a user isn't exploiting the system 1. This concept may also be applied in the scenario where the user completes a required time identifier indicative of a time requirement to complete a course but has screens that still need to be viewed. For example, if a user completes a time requirement of three hours, but the user still has ten (10) slides to view, the system 1 may designate a minimum view threshold per screen that represents the minimum amount of time that the user is required to view each of the remaining screens. In this case, the minimum view threshold may be two minutes so that the user may hopefully retain information found on each screen. Additionally, the minimum view threshold for each screen may be varied based on the amount of information found on each individual screen.

In an illustrative process of the embodiment presented in FIG. 2, the method 200 may commence when a students starts 210 an online driver's education course. During the course, the computer system 1 will analyze whether a student has met the “course time requirement” for the course as prescribed by a regulatory body; this “course time requirement” may be recognized as the threshold identifier. The computer system 1 may determine if the course time requirement (the threshold identifier) has been met 220 by the student. If the course time requirement has not been met, the computer system 1 may calculate, for example, a “words per minute” (“WPM”) value 230 that generally corresponds to a “word count” per screen divided by a time differential (“dT” or “delta-time”), where the time differential is equal to the course time requirement minus the time a student has already spent in the course (where the time a student has already spent in the course is the learning period identifier). Upon the calculation of the WPM, the computer system 1 will then set and optionally display a screen timer, or a screen view identifier, based upon the newly calculated WPM 240.

The computer system 1 will then advance to the next screen of the course 250. The computer system will then determine if this next screen is the last screen of the course 260; if it is not the last screen, the computer system 1 will repeat the process 270 and again calculate if the course time requirement (the threshold identifier) has been met 220 by the student. In the event the course time requirement (the threshold identifier) has been met by the student, or a situation where the time differential is equal to “zero,” then the computer system 1 will set the screen timer, or a screen view identifier, to “zero” 280 thereby indicating to the student that the course time requirement (the threshold identifier) has been reached. When the computer system 1 determines that the student has reached the last screen it will then end the course 290. The computer system may also measure “average” WPM values for the student participants to report such average values to a regulatory body, such as a Department of Motor Vehicles, in order to improve the online course.

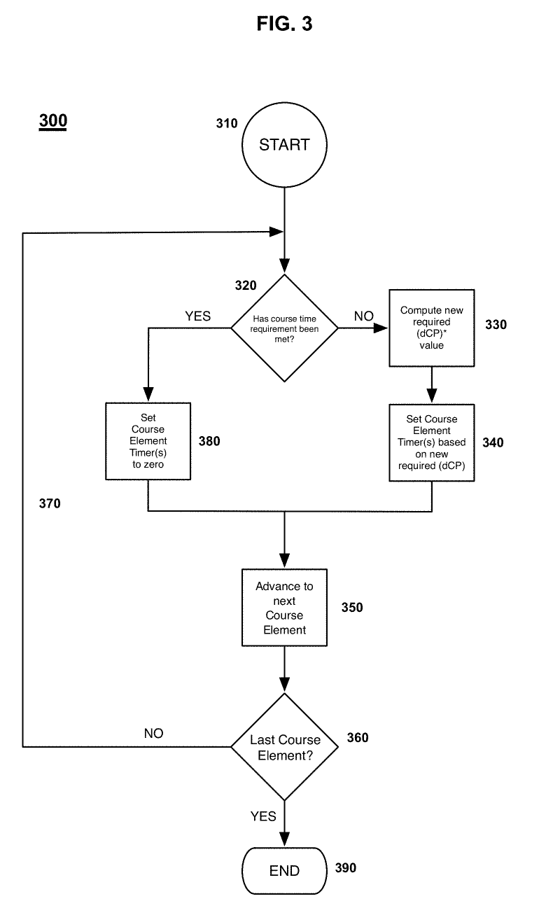

In a further embodiment, depicted in FIG. 3, the “screen” of the aforementioned embodiment depicted in FIG. 2 may be replaced by a “course element,” where the course element is an arbitrary collection of organized electronic course content. For example, a course element may be the aforementioned screen or may be a webpage, a chapter, a level, completion of a course milestone, or any other organizational unit of an electronic course. In this further embodiment, in lieu of the WPM, a “course property” may be used, where such “course property” may be the course word count as described in the embodiment presented in FIG. 2 but may also correspond to another property of the electronic course, such as a number of sentences, number of paragraphs, or a number of quiz questions.

In an illustrative process of the embodiment presented in FIG. 3, the method 300 may commence when a students starts 310 an online driver's education course. During the course, the computer system 1 will analyze whether a student has met the “course time requirement” for the course as prescribed by a regulatory body; this “course time requirement” is the threshold identifier. The computer system 1 may determine if the course time requirement (the threshold identifier) has been met 320 by the student. If the course time requirement has not been met, the computer system 1 may calculate a “course property per time unit” (or “delta-Course Property” (“dCP”)) value 330 that generally corresponds to a “course property” measurement for each “course element” divided by a time differential (“dT” or “delta-time”), where the time differential is equal to the course time requirement minus the time a student has already spent in the course (where the time a student has already spent in the course is the learning period identifier). Upon the calculation of the dCP, the computer system 1 will then set and optionally display a course element screen timer (or a screen view identifier) based upon the newly calculated dCP 340.

The computer system 1 will then advance to the next course element of the electronic course 350. The computer system will then determine if this next course element is the last course element of the course 360; if it is not the last course element, the computer system 1 will repeat the process 370 and again calculate if the course time requirement (the threshold identifier) has been met 320 by the student. In the event the course time requirement (the threshold identifier) has been met by the student, or a situation where the time differential is equal to “zero,” then the computer system 1 will set the course element screen timer (or a screen view identifier) to “zero” 380 thereby indicating to the student that the course time requirement (the threshold identifier) has been reached. When the computer system 1 determines that the student has reached the last course element it will then end the course 390. The computer system may also measure “average” dCP values for the student participants to report such average values to a regulatory body, such as a Department of Motor Vehicles, in order to improve the online course.

In embodiments, computer system 1 may perform specific operations by processor 3 executing one or more sequences of one or more instructions stored in system memory 4 (e.g., executable instructions embodied in a non-transitory computer readable medium), and computer system 1 may be implemented in a client-server arrangement, peer-to-peer arrangement, or as any mobile computing device, including smart phone, etc. Such instructions or data may be read into system memory 4 from another computer readable medium, such as, but not limited to remote computer 30. In some examples, hard-wired circuitry may be used in place of or in combination with software instructions for implementation. In embodiments, instructions may be embedded in software or firmware. The term “non-transitory computer readable medium” may refer to any tangible medium that participates in providing instructions to processor 3 for execution. Non-transitory computer readable medium is not limited to any specific form.

For example, one or more of steps 210-290 and/or 310-390 may be instructions in the form of code executable by the non-transitory computer readable medium (such as system memory 4). Instructions for providing adaptive timing may include instructions for identifying, via a processor, a learning period identifier of a user that is indicative of an amount of course content that the user has completed. Instructions for comparing the learning period identifier to a threshold identifier to calculate a time differential between the learning period identifier and the threshold identifier may then be executed. Next, instructions for calculating, via the processor, an average screen view identifier for a remainder of the plurality of screens utilizing the time differential may be executed. And additionally, instructions for utilizing the image viewer to present the average screen view identifier to the user for the remainder of the plurality of screens may then be executed.

For the purposes of this disclosure, the terms “processor” and “processing unit” may be synonymous and may be identified with the numeral 3 in the figures.

For the purposes of this disclosure, the terms “monitor” and “image viewer” may be synonymous and may be identified with the numeral 25 in the figures.

For the purposes of this disclosure, the terms “course” and “computer program” may be synonymous.

For the purposes of this disclosure, the terms “online program”, “program”, “online course”, and “course” may be synonymous.

I claim:

1. A method, performed by a computer of the type having an image viewer and a processor, for providing adaptive timing of a computer program comprising a plurality of screens, the method comprising:
identifying, via a processor, a learning period identifier of a user that is indicative of an amount of course content that the user has completed;
comparing the learning period identifier to a threshold identifier to calculate a time differential between the learning period identifier and the threshold identifier;
calculating, via the processor, an average screen view identifier for a remainder of the plurality of screens utilizing the time differential; and
utilizing the image viewer to present the average screen view identifier to the user for the remainder of the plurality of screens.

2. The method of claim 1, further comprising removing the average screen view identifier from the remainder of the plurality of screens.

3. The method of claim 1, further comprising recalculating the average screen view identifier after the user has viewed at least one of the plurality of screens.

4. The method of claim 1, further comprising recalculating the average screen view identifier after each time the user has viewed one of the plurality of screens.

5. The method of claim 1, further comprising inserting breaks in between at least two of the screens of the remainder of the plurality of screens.

6. The method of claim 1, further comprising providing a minimum view threshold for each of a remainder of the plurality of screens once an individual has completed a required time identifier indicative of a time requirement to complete the computer program.

7. A system for providing adaptive timing of a computer program, the system comprising:
an identified learning period identifier of a user that is indicative of an amount of course content that the user has completed;
an identified threshold identifier for comparison with the identified learning period identifier to calculate a time differential between the learning period identifier and the threshold identifier;
a computer comprising a processor configured to:
calculate an average screen view identifier for a remainder of the plurality of screens utilizing the time differential; and
an image viewer configured to:
present the average screen view identifier to the user for the remainder of the plurality of screens.

8. The system of claim 7, wherein the average screen view identifier is absent from the remainder of the plurality of screens.

9. The system of claim 7, wherein the average screen view identifier is recalculated after the user has viewed at least one of the plurality of screens.

10. The system of claim 7, wherein the average screen view identifier is recalculated after each time the user has viewed one of the plurality of screens.

11. The system of claim 7, wherein breaks are inserted in between at least two of the screens of the remainder of the plurality of screens.

12. The system of claim 7, wherein a minimum view threshold for each of a remainder of the plurality of screens is provided once an individual has completed a required time identifier indicative of a time requirement to complete the computer program.

13. A non-transitory computer readable medium including executable instructions for providing adaptive timing, comprising:
instructions for identifying, via a processor, a learning period identifier of a user that is indicative of an amount of course content that the user has completed;
instructions for comparing the learning period identifier to a threshold identifier to calculate a time differential between the learning period identifier and the threshold identifier;
instructions for calculating, via the processor, an average screen view identifier for a remainder of the plurality of screens utilizing the time differential; and
instructions for utilizing the image viewer to present the average screen view identifier to the user for the remainder of the plurality of screens.

14. The non-transitory computer readable medium of claim 13, further comprising instructions for removing the average screen view identifier from the remainder of the plurality of screens.

15. The non-transitory computer readable medium of claim 13, further comprising instructions for recalculating the average screen view identifier after the user has viewed at least one of the plurality of screens.

16. The non-transitory computer readable medium of claim 13, further comprising instructions for recalculating the average screen view identifier after each time the user has viewed one of the plurality of screens.

17. The non-transitory computer readable medium of claim 13, further comprising instructions for inserting breaks in between at least two of the screens of the remainder of the plurality of screens.

18. The non-transitory computer readable medium of claim 13, further comprising instructions for providing a minimum view threshold for each of a remainder of the plurality of screens once an individual has completed a required time identifier indicative of a time requirement to complete the computer program.
